(19) United States
(12) Patent Application Publication
(10) Pub. No.: US 2002/0157774 A1
(43) Pub. Date: Oct. 31, 2002

(54) Ferrule manufacture method and ferrule

(76) Inventors: Katsuki Suematsu, Tokyo (JP); Yasushi Kihara, Tokyo (JP)

Correspondence Address: KNOBBE MARTENS OLSON & BEAR LLP, 2040 MAIN STREET, FOURTEENTH FLOOR, IRVINE, CA, 91614, US

(21) Appl. No.: 09/957,435

(22) Filed: Sep. 19, 2001

(30) Foreign Application Priority Data
Apr. 27, 2001 (JP) 2001-132146

(51) Int. Cl. B29C 47/00

(52) U.S. Cl. 156/245; 156/296

(57) ABSTRACT

A ferrule manufacture method for molding, with a die, a ferrule having pin holes each for inserting a guide pin therethrough; a plurality of fiber holes provided between the pin holes each for inserting an optical fiber therethrough, and an inlet port for introducing optical fibers therein, in which the optical fibers are adhered and fixed to the fiber holes with adhesive injected from the inlet port, and the ferrule. A plurality of pins for forming a plurality of fiber holes are held by a holding member, and a support member for supporting the guide pins or the holding member is located in the molding process within the die between positions corresponding to a front end face and a rear end face of the ferrule to be molded.

### FIELD OF THE INVENTION

The present invention relates to a ferrule manufacture method and a ferrule.

### BACKGROUND OF THE INVENTION

Some of ferrules for optical connectors are molded from synthetic resin for easy manufacture and cost reduction. The ferrules made of synthetic resin as described above, for instance, ferrules for mutifiber connectors may sometimes shrink after being molded due to imbalance between the synthetic resin used for forming a ferrule and a variety of spatial arrangements formed in the ferrule. Due to deformation associated with the shrinkage as described above, in the molded ferrule, a pin hole for passing a guide pin therethrough and a fiber hole for inserting an optical fiber therethrough deforms. Therefore, there has been the problem that, when the optical connector using therein the ferrule as described above is connected to other optical connector, optical axes of the mutually connected optical fibers displace from each other to cause degradation of the optical characteristics.

To evade the troubles as described above, there has been proposed a ferrule generally called as window-less ferrule which can overcome the imbalance described above by, for instance, eliminating a window for injecting a filler to adhere and fix an optical fiber in a fiber hole and also by forming the ferrule in the plane symmetry against the plane on which a plurality of fiber holes each for inserting an optical fiber therethrough are arrayed (Refer to Unexamined Japanese Patent Publication (KOKAI) No. 2000-56174).

### SUMMARY OF THE INVENTION

It is an object of the present invention to provide a method of manufacturing a ferrule in which a pin for forming a fiber hole is not deformed during the forming process by the pressure for injecting synthetic resin and also which is excellent in the forming precision of the fiber hole and also to manufacture the ferrule.

To achieve the objects described above, according to the present invention, a method of manufacturing, with a die, a ferrule comprising pin holes each for inserting a guide pin therethrough, a plurality of fiber holes formed between said pin holes each for inserting an optical fiber therethrough, and an inlet port communicated to said plurality of fiber holes each for inserting said optical fiber therethrough, said optical fiber adhered and fixed to said fiber holes with adhesive injected from said inlet port, is constructed in such a way that a plurality of pins for forming said plurality of fiber holes are held by a holding member, a support member for supporting said pins or holding member is provided between positions corresponding to a front end face and a rear end face of the ferrule to be molded within the die, and said holding member is positioned within the die when molding.

Further to achieve the objects described above, the ferrule according to the present invention is constructed in such a way that the ferrule is manufactured by the ferrule production method according to the present invention described above, and in the ferrule, a plurality of fiber holes each for inserting an optical fiber therethrough are formed between the pine holes for inserting a guide pine therethrough and communicated to said plurality of fiber holes, and the ferrule has an open inlet port for injecting adhesive to adhere and fix said optical fiber to said fiber hole on the rear end face.

With the present invention, it is possible to provide a method of manufacturing a ferrule in which a pin for forming a fiber hole is not deformed due to the synthetic resin injection pressure during molding and also which is excellent in the filer hole molding precision and also to provide the ferrule.

The above-described and other objects, features and advantages of the present invention will be understood more clearly by referring to the detailed description of the present invention as well as to the attached drawings.

### BRIEF DESCRIPTION OF THE DRAWINGS

FIG. 1 shows one embodiment of the ferrule manufacture method and ferrule according to the present invention, and is a perspective view showing the manufactured ferrule;

FIG. 2 is a perspective view showing a lower part and a core of a die used for manufacturing the ferrule shown in FIG. 1, and a pin molded with the die;

FIG. 3 is a cross-sectional view showing the die used for manufacturing the ferrule in FIG. 1 in the closed state;

FIG. 4 is a cross-sectional view taken along the line Cl to Cl in FIG. 3;

FIG. 5 is a cross-sectional view taken along the line C2 to C2 in FIG. 3;

FIG. 6 is a cross-sectional view taken along the line C2 to C2 in FIG. 3 and shows an embodiment in which two support blocks are used;

FIG. 7 is a model diagram showing a flow of synthetic resin in the cavity shown in FIG. 6;

FIG. 8 is a model diagram showing a flow of synthetic resin in a cavity in an embodiment of the present invention shown in FIG. 6 in which the support block has a cylindrical form;

FIG. 9 is a cross-sectional view taken along the line C2 to C2 in FIG. 3 and shows an embodiment of the present invention in which the core is supported by two support blocks provided above and under the core;

FIG. 10 is a cross-sectional view of a ferrule molded with the support blocks shown in FIG. 9;

FIG. 11 is a cross-sectional view taken along the line C2 to C2 in FIG. 3 and shows an embodiment in which two pairs each comprising the upper and lower support blocks shown in FIG. 9 are used;

FIG. 12 is a perspective view showing a variant of the core;

FIG. 13 is a cross-sectional view of a ferrule molded with the core shown in FIG. 12; and

FIG. 14 is a front view showing another positioning block used for positioning one edge of a molded pin for forming a pin hole and a molded pin for forming a fiber hole.

### DETAILED DESCRIPTION OF THE INVENTION

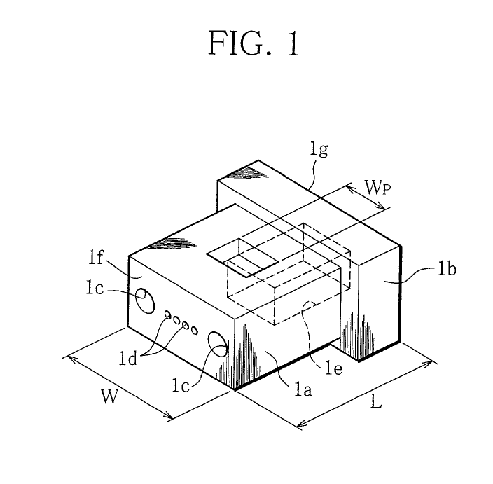

An embodiment of a ferrule manufacture method and a ferrule according to the present invention is described in detail below with reference to FIG. 1 through FIG. 14.

At first, description is made for a ferrule manufactured by the manufacture method according to the present invention.

As shown in FIG. 1, a ferrule 1 has a flange 1b formed at a rear section of a main body 1a and slightly projecting in the vertical as well as in the horizontal directions. The ferrule 1 has two pin hoes 1c each for inserting a guide pin therethrough and four fiber holes Id each for inserting an optical fiber therethrough formed between the two pin holes 1cspaced from each other at a prespecified distance in the longitudinal direction. The main body 1a has an inlet port 1efor injecting adhesive to adhere and fix the optical fiber to the fiber hole id, the inlet port 1e communicated to the plurality of fiber holes Id and also opened on a rear end face 1g.

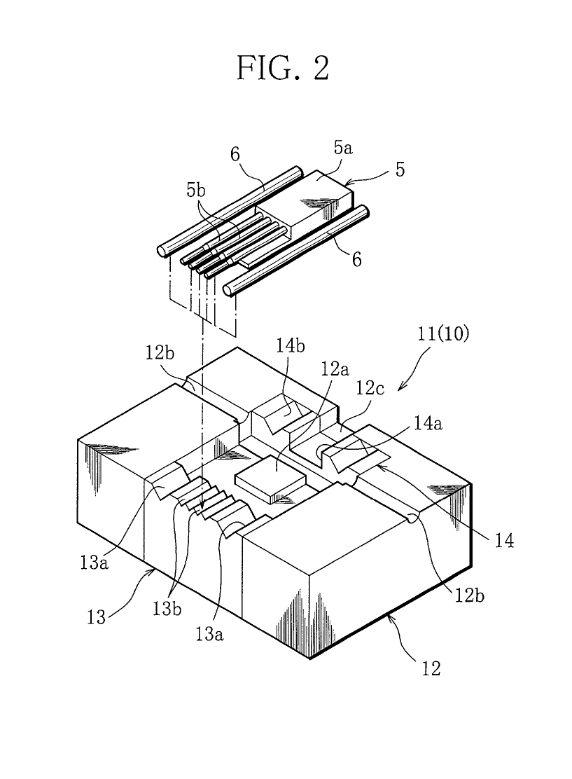

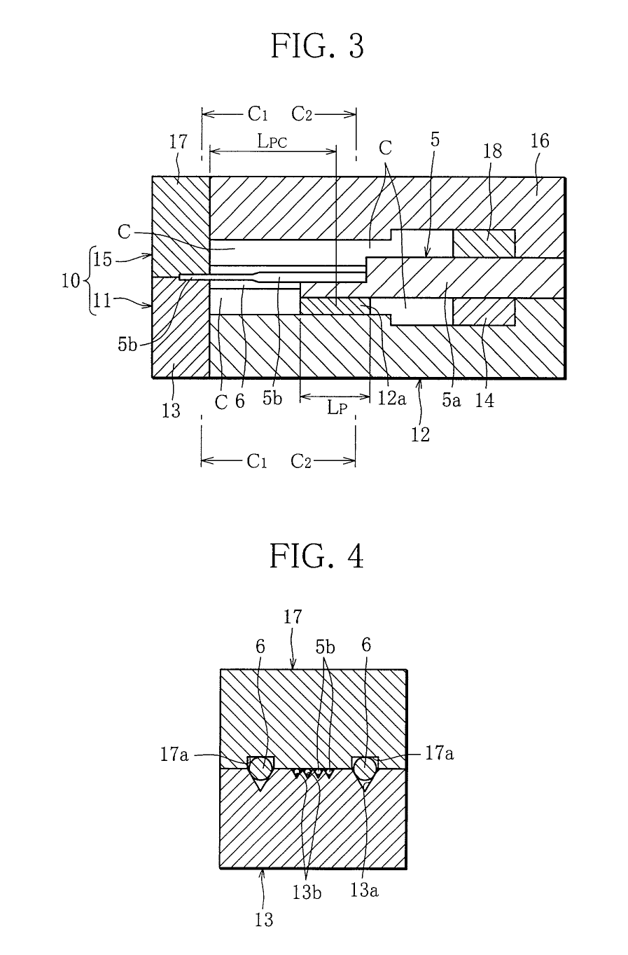

The ferrule 1 having the configuration as described above is manufactured, as shown in FIG. 2 and FIG. 3, using a die 10 having a core 5, molding pins 6, and also comprising a lower die 11 and an upper die 15 according to the manufacture method described below.

The core 5 has four molding pins 5b each for forming the fiber hole 1d on a main body 5a for forming the inlet port le as shown in FIG. 2. On the other hand, the molding pin 6 is a pin for forming the pin hole 1c having a larger diameter than the fiber hole 1d.

The lower die 11 has a base block 12, a first positioning block 13, and a second positioning block 14 as shown in FIG. 2.

The base block 12 has the first positioning block 13 and the second positioning block 14 provided in the front side and in the rear side respectively, and a support block 12a for supporting the core 5 is provided between positions corresponding to a front end face if and a rear end face 1g of the ferrule 1 to be molded. The base block 12 has a groove 12b for forming a flow path for resin at the side of the section adjoining the second positioning block 14 and corresponding to the flange 1b of the ferrule 1 as shown in FIG. 2. Further the base block 12 has a recessed groove 12c having the same form as a recessed groove 14a of the second positioning block 14 described hereinafter and provided at a position corresponding to the recessed groove 14a, as shown in FIG. 2.

Assuming that a length of the ferrule 1 in the longitudinal direction is L, and a width thereof in the lateral direction perpendicular to the longitudinal direction is W (Refer to FIG. 1), the support block 12a forms the ferrule 1 so that the length Lp in the longitudinal direction and width Wp of the ferrule 1 (Refer to FIG. 1 for each), and the distance Lpc from a position corresponding to the front end face If of the ferrule 1 to a central position in the longitudinal direction satisfy the following equations:

Lp≦L/8, Wp≦W/3

(3/8)L≦Lcp≦(5/8)L

The first positioning block 13 has V-grooves 13a for locating molding pins 6 in both left and right sides on the upper surface thereof and V-grooves 13b for locating the molding pins 5b between the V-grooves 13a as shown in FIG. 2 and FIG. 4.

The second positioning block 14 has a recessed groove 14a provided at a center in the lateral direction for arranging the main body 5a of the core 5 therein and V-grooves 14b for arranging the molding pins 6 at the both sides from the recessed groove 14a as shown in FIG. 2.

The upper die 15 has a base block 16, a first positioning block 17, and a second positioning block 18 as shown in FIG. 3, and has the substantially same configuration as the lower die 11. Therefore, in the descriptions and drawings below, the same reference numbers are used for the same components as those in the lower die 11, and detailed description thereof is omitted herein. It should be noted that the first positioning block 17 has grooves 17a for locating the molding pins 6 which are not V-shaped, and does not have the V-grooves for locating the molding pins 5b.

To manufacture the ferrule 1 by using the die 10, at first, the core 5 and two molding pins 6 are set in the lower die 11 making use of the first positioning block 13 and second positioning block 14.

In this step, each of the molding pins 6 is spanned over the section between the V-groove 13a and V-groove 14b. Further the main body 5a of the core 5 is set in the lower die by making use of the recessed group 14a and support block 12a with each of the molding pins 5b set in the corresponding V-groove 13b.

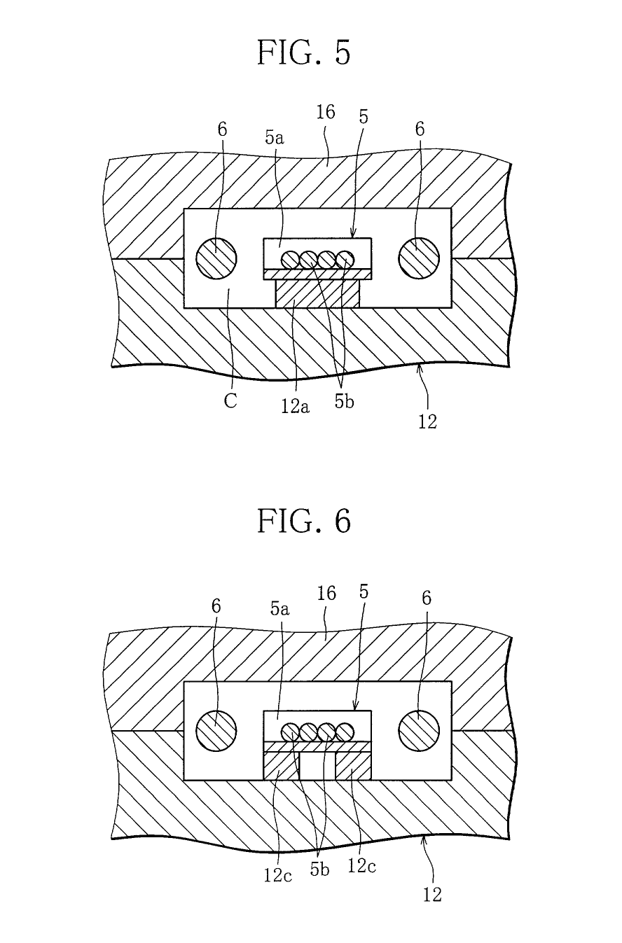

Next, the upper die 15 is set from above, and the die 10 is closed as shown in FIG. 3. With this operation, a cavity C (Refer to FIG. 3 and FIG. 5) for molding the ferrule 1 is formed with the lower die 11 and upper die 15 within the die 10, and a flow path for synthetic resin is formed at a position at the side from the flange 1b of the ferrule 1 with the groove 12b and a groove (not shown) in the base block 16. Within the closed die 10, one end side of the molding pin 5b is fixed and supported by the V-groove 13b and first positioning block 17 and the other end side thereof via the main body 5a of the core 5 by the support block 12a and the second positioning blocks 14, 18 (Refer to FIG. 3) respectively.

Then melted synthetic resin, for instance, polyphenylene sulfide (PPS) or epoxy resin is filled through the resin flow path described above in the cavity C. With this operation, the ferrule 1 corresponding to a form of the cavity C as shown in FIG. 1 is formed. After a prespecified period of time, the die 10 is opened and the ferrule 1 as a molded item is taken out.

The melted synthetic resin is filled in the cavity C under a high pressure, as described above, one end section of the molding pin 5b is fixed and supported by the V-groove 13b and first positioning block 17 (Refer to FIG. 4) and the other end section thereof via the main body 5a of the core 5 by the support block 12a and second positioning blocks 14, 18 (Refer to FIG. 3) respectively.

Because of this configuration, with the method according to the present invention, it is possible to manufacture the ferrule 1 with fiber holes formed thereon with high precision without the molding pins 5b being deformed due to the pressure for injection of synthetic resin in the molding step.

In contrast, the window-less ferrule disclosed in Unexamined Japanese Patent Publication (KOKAI) No. 2000-56174 is molded with a die, but in this case, pins for forming a plurality of fiber holes can not fully be held between positions corresponding to a front end face and a rear end face of the ferrule within the die in the molding step.

Because of this feature, the window-less ferrule described above has the problem that the pins for forming fiber holes is deformed within the die due to the pressure for injecting synthetic resin in the molding step with the fiber hole molding precision lowered.

In the die 10, the melted synthetic resin is injected into the cavity C from the second positioning block 14 in the rear section and flows to the first positioning block 13 in the front section. In this step, the core 5 is supported by the laterally long support block 12a as shown in FIG. 5. Because of this configuration, sometimes the synthetic resin is prevented by the support block 12a and does not smoothly flow.

To overcome this problem, the two support blocks 12c are used. Namely, as shown in FIG. 6, the core 5 is supported by the two support blocks 12c provided at a space therebetween and each having a form like a quadratic prism. With this configuration, there is generated between the two support blocks 12c a space in which the synthetic resin can smoothly flow as shown in FIG. 6.

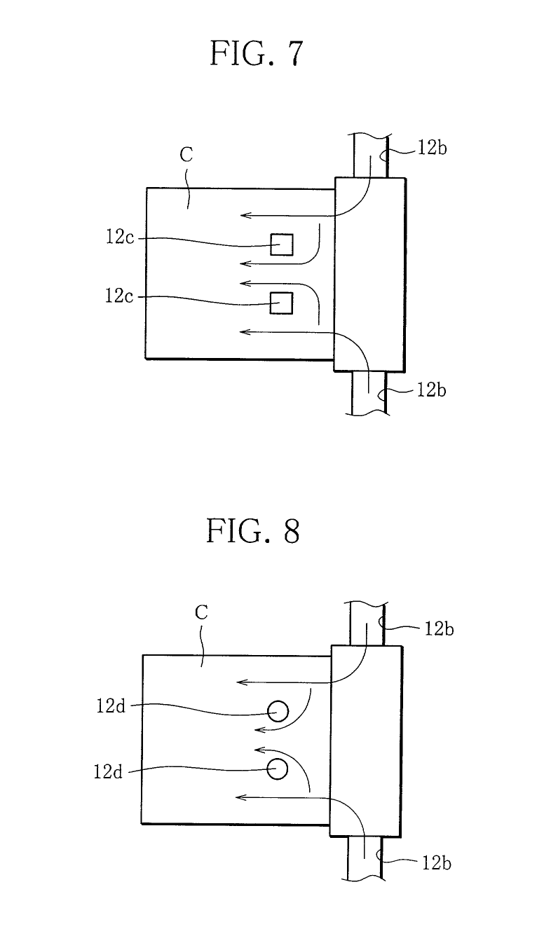

Therefore, the synthetic resin smoothly flows under the core 5 through a section between the two support blocks 12c as shown in FIG. 7, and adaptability of the ferrule 1 to be molded is improved. Especially, when the two support blocks 12c are used, its adaptability to being filled with the synthetic resin is remarkably improved in the case where a molding method such as the injection molding method with synthetic resin having high viscosity is used for molding, and the molding precision of the ferrule 1 is improved.

To show a flow of synthetic resin in the cavity C, in FIG. 7 and FIG. 8, the core 5 and two molding pins 6 are not shown.

When the core 5 is supported by the two support block 12d each having a form like a column, the synthetic resin flows more smoothly as compared to the case where the support blocks 12c each having a form like a quadratic prism, so that the molding precision of the ferrule 1 is further improved.

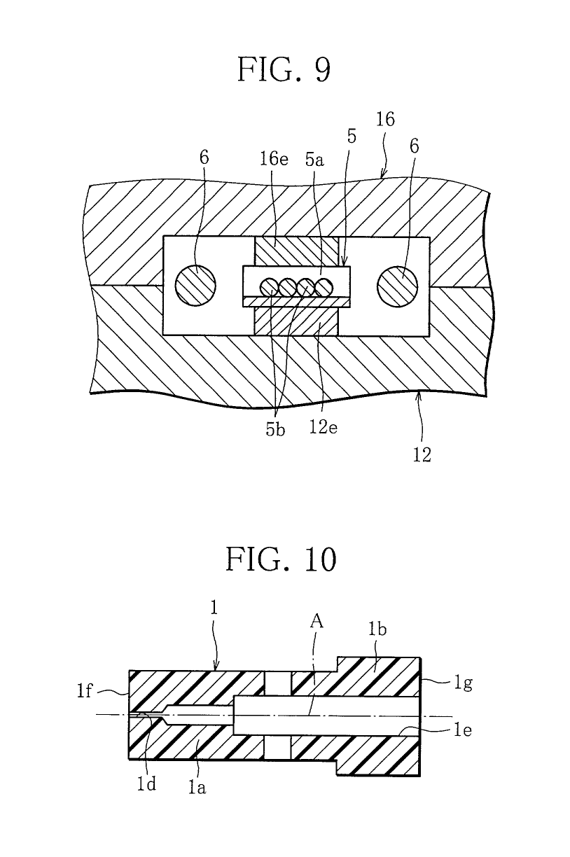

On the other hand, in FIG. 9, the core 5 is supported by the two support blocks 12e and 16e arranged above and under the core 5. With this configuration, as shown in FIG. 10, the ferrule 1 is molded into a form which is symmetrical in the vertical direction against the center line A passing through a center of each fiber hole id, and in this case, the following advantages are provided in addition to improvement of the molding precision.

Namely, the molded ferrule 1 is assembled with an optical connector by adhering and fixing an optical fiber (not shown) inserted into the fiber hole id with an adhesive filled from the inlet port le. An expansion coefficient of the adhesive used in this step is different from that of the synthetic resin used for forming the ferrule 1. Therefore, unless the ferrule 1 is formed symmetrically in the vertical direction, when the assembled optical connector is installed, for instance, at a site where the environmental temperature changes largely, the assembled optical connector may deform into an imbalanced form.

On the contrary, when the ferrule 1 has a vertical symmetrical form as shown in FIG. 10, even if the environmental temperature changes, upper and lower portions of the optical connector using the ferrule 1 therein changes homogeneously, so that imbalanced deformation due to change in the environmental temperature is suppressed. Because of this feature, when the optical connector using therein the ferrule shown in FIG. 10 is butt-jointed to another optical connector, the light axes of the connected optical fibers never displace from each other, and degradation of the optical characteristics can be prevented.

In FIG. 11, in place of the support blocks 12e and 16e, two pieces of supporting blocks 12f and two pieces of supporting blocks 16f are provided above and under the core 5. In this case, when the ferrule 1 is molded, synthetic resin smoothly flows betweens the two support blocks 12f and between the two support blocks 16f above and under the core 5 respectively. Therefore when the core 5 is supported by the support blocks 12f and 16f, adaptability of the ferrule 1 to be molded is further improved.

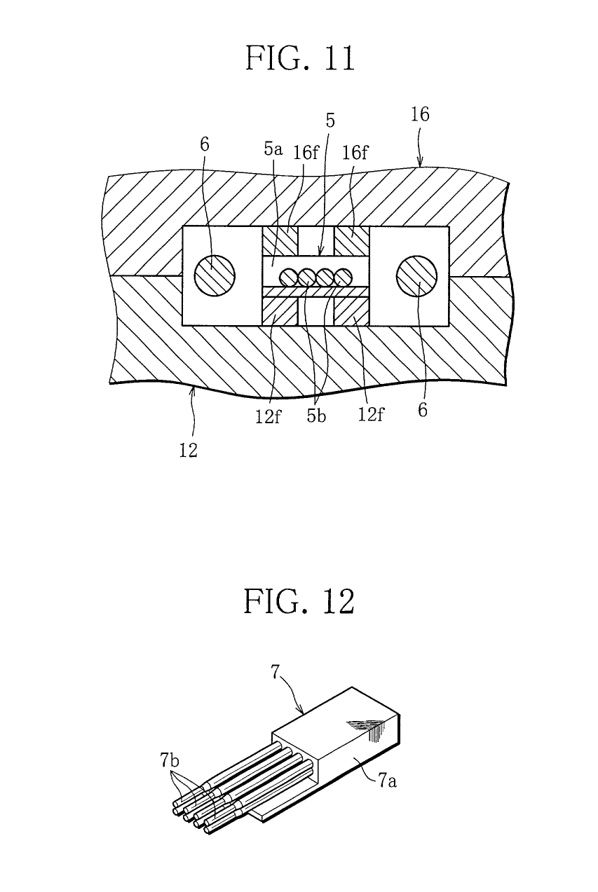

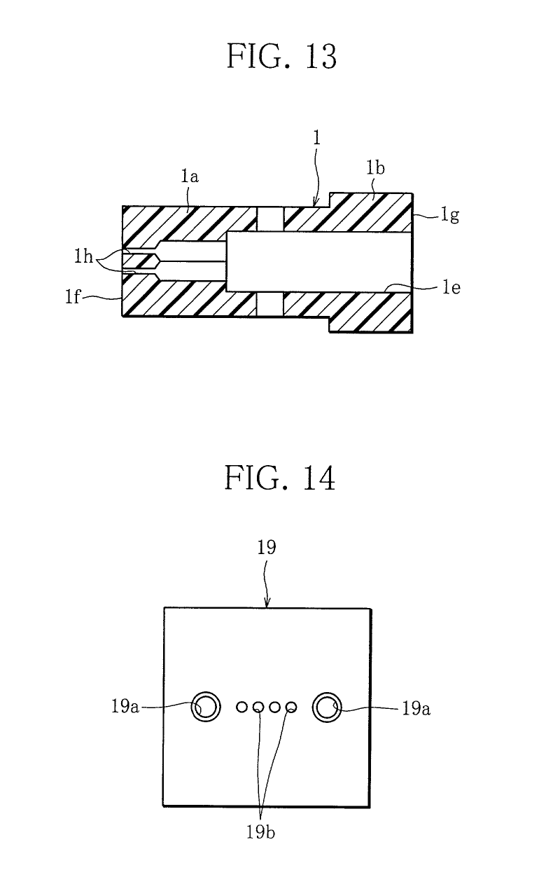

Further, in place of the core 5 shown in FIG. 2, a core 7 with four molding pins 7b for forming the fiber holes in the main body 7a provided in upper and lower stages which are vertical symmetrical against a line passing through a center of the two pin holes 1c as shown in FIG. 12 may be used. When this core 7 is used, it is possible to mold the ferrule 1 with four fiber holes 1h provided in the upper and lower stages as shown in FIG. 13.

When the core 7 is used, however, tips of the molding pin 7b and molding pin 6 are positioned by using a positioning block 19 shown in FIG. 14 in place of the first positioning blocks 13 and 17. The positioning block 19 has positioning holes 19a, into which a tip of the molding pin 6 is inserted for positioning, formed in the left and right sides thereof and also has four positioning holes 19b each for positioning the molding pin 7b formed in the upper and lower stages respectively between the two positioning holes 19a.

The method of manufacturing a ferrule with four fiber holes was described in each of the embodiments above, but it is needless to say that a number of the fiber holes is not limited to four.

What is claimed is:

1. A ferrule manufacture method for molding, with a die, a ferrule having pin holes each for inserting a guide pin therethrough: a plurality of fiber holes provided between said pin holes each for inserting an optical fiber therethrough; and an inlet port communicated to said plurality of fiber holes into which said optical fiber is introduced, said optical fiber adhered and fixed to said fiber hole with adhesive injected from said inlet port,
wherein a plurality of pins for forming said plurality of optical fiber holes are held by a holding member, a support member for supporting said pins or said holding member is arranged between positions corresponding to a front end face and a rear end face of said ferrule to be molded, and said holding member is positioned within said die in the molding step.

2. The ferrule manufacture method according to claim 1, wherein, assuming that a length of said ferrule in the longitudinal direction is L, and a width thereof in the lateral direction perpendicular to the longitudinal direction is W, said support member is arranged so that the length Lp in the longitudinal direction and width Wp of said ferrule, and the distance Lpc from a position corresponding to the front end face of said ferrule to a central position in the longitudinal direction satisfy the following equations:
Lp≦L/8, Wp≦W/3
(3/8)L≦Lcp≦(5/8)L.

3. The ferrule manufacture method according to claim 1, wherein two or more pieces of said support members are used.

4. The ferrule manufacture method according to claim 2, wherein two or more pieces of said support members are used.

5. The ferrule manufacture method according to claim 3, wherein said support member has a form like a column.

6. The ferrule manufacture method according to claim 4, wherein said support member has a form like a column.

7. The ferrule manufacture method according to claim 3, wherein said die has an upper die and a lower die each having said support member provided therein.

8. The ferrule manufacture method according to claim 4, wherein said die has an upper die and a lower die each having said support member provided therein.

9. The ferrule manufacture method according to claim 5, wherein said die has an upper die and a lower die each having said support member provided therein.

10. The ferrule manufacture method according to claim 6, wherein said die has an upper die and a lower die each having said support member provided therein.

11. A ferrule manufactured by the manufacture method according to claim 1,
wherein a plurality of fiber holes each for inserting an optical fiber therethrough are formed between pin holes each for inserting a guide pin therethrough, and said ferrule has an inlet port communicated to said plurality of fiber holes and opened on a rear end face for injecting adhesive to adhere and fix said optical fiber to said fiber holes therefrom.
